(19) United States
(12) Patent Application Publication
(10) Pub. No.: US 2023/0136234 A1
(43) Pub. Date: May 4, 2023

(54) ID CARD AND METHOD FOR MANUFACTURING SAME, ID CARD ISSUING DEVICE AND SYSTEM, AND FACE AUTHENTICATION DEVICE AND SYSTEM

(71) Applicant: AI & DI CO., LTD., Osaka (JP)

(72) Inventor: Atsumi IHARA, Osaka (JP)

(21) Appl. No.: 17/918,550

(22) PCT Filed: Apr. 13, 2020
(86) PCT No.: PCT/JP2020/016254

§ 371 Date: Oct. 12, 2022

(51) Int. Cl. H04L 9/08

(52) U.S. Cl. CPC H04L 9/0866; H04L 9/0877

(57) ABSTRACT

Provided is an ID card issuing device configured to: execute a process on an IC card including an IC chip, a memory, and a function for communicating with the outside; and issue an ID card for user identification. The ID card enables face authentication of users, and can reduce the time required for face authentication. The device includes: a data processing unit that generates, based on image data representing an image including the face of a user, feature data representing information related to feature points extracted from the image including the face of the user, that encrypts data including the feature data and user identification information using a unique ID code in the IC chip as an encryption key, and that creates an identification data file including the encrypted data; and a write control unit for storing the identification data file in the IC card memory.

### CROSS-REFERENCE TO RELATED APPLICATIONS

This application is the U.S. national phase of International Application No. PCT/JP2020/016254 filed Apr. 13, 2020 which designated the U.S., the entire contents of which is hereby incorporated by reference.

### BACKGROUND OF THE INVENTION

### Field of the Invention

The present invention relates to an ID card used for identifying a user for Access management in a facility or a settlement in a financial institution, and a method of manufacturing an ID card. Further, the present invention relates to an ID card issuing device and an ID card issuing system to issue ID cards. Further, the present invention relates to a face authentication device and a face authentication system to perform face authentication of a user with an ID card.

### Description of the Related Art

For example, in Access management in a facility or in a settlement in a financial institution, personal identification using an ID card is performed in order to allow only a registered person to access, or to allow only a registered person to operate the terminal. However, when the identification information is read from the ID card or the user is allowed to input the identification number, there is a large risk that the personal identification will be insufficient and illegally carried out by the so-called impersonation.

Thus, fingerprint authentication and vein authentication have also been used for identification. In this case, for example, it may be considered that a server is connected to an authentication device including a fingerprint sensor or a vein sensor via a network and a data for authentication of all users is stored in advance in the server, but the configuration of the entire system becomes large and expensive. Since the finger print and the vein authentication are possible even in a state of intoxication or a state of unconsciousness, there is a risk to recognize there is a person's intention even if the feature of the fingerprint or the vein is coincidence with what are registered.

As a related technology, in Patent Document 1, there is disclosed an attendance management system to record a time of the recording operation of an user, which can identify an operator himself/herself easily and prevent the punching by a different user. This system is provided with a collation data holding means to hold face image information and personal information of a plurality of users as a collation data, a camera which photographs a face of an operating person, a collation means which collates the image data photographed by the camera with a collation data held in the collation data holding means, the user selection means which display the collation data held in the collation data holding means in a state of being selectable by an operator in the case when the collation result is not judged to be positive by the collation means, and the operation registration means which enables the operation and registers the stamped time data as stamped data with a collation data determined to be the collation positive and the collation data selected by the user selection means in the case when the collation is judged to be positive by the collation means, or when the selection is performed by the user selection means.

In addition, in Patent Document 2, there is disclosed a working management device which can prevent the punching operation of impersonation by using a simple and inexpensive configuration. This working management device is provided with a worker information input part to read the card data unique to a worker from an ID card unique to a worker when recording operation by a worker. This ID card is provided with a punching operation part to record the time of the operation, which means reading the data from an ID card, when reading the card data and the card data including of the punching information corresponding to the punching operation and the recording unit to store the punching information. In this case, the recording unit records face detection necessity information indicating whether or not the face image of the worker needs to be detected at the time of the punching operation as the worker information which can identify the worker corresponding to the unique card information. In the case the face detection necessity information indicates that the operator needs to be detected his/her face, the working management device record the punching data through photographing the image of the operator punching at the punching unit and in the case the face detection necessity information indicates that the operator does not need to be detected his/her face, the working management device records the punching data without photographing the image of the operator.

### PRIOR ART REFERENCE

### Patent Document

[Patent document 1]Japanese Patent Application Laid-open No. 2006 48326 (paragraphs 0006 to 0012, FIG. 1, FIG. 3).

[Patent document 2]Japanese Patent Application Laid-open No. 2018 195345 (paragraphs 0010 to 0011, FIG. 1 to FIG. 3).

### SUMMARY OF THE INVENTION

According to Patent Document 1, if the collation score obtained by collating the image information captured by the camera with the collation data held in the collation data holding means is equal to or larger than a threshold value, the collation is judged to be positive and the operation is permitted, so that the illegal operation by the different person can be suppressed. In addition, when it is determined that the collation is not positive, a plurality of pieces of the collation data are displayed and selected by the operator. The selected collation data is also registered as the stamp data, so that it is possible to surely perform the identification at the time of the collation failure.

However, in Patent Document 1, the face collation is to identify an individual with the facial characteristics of a face image captured by a camera and identify an user of the users registered in the collation data holding means (Paragraph 0023). Since the detailed face image information is required to perform such a collation, the amount of data of the collation data becomes large, the time required for collation is long, and the identification at the time of a collation failure is complicated. Further, since it is necessary to store the face image information and the personal information of all users in advance in the collation data holding means, there is a possibility that the correspondence between the face image information and the personal information may be confused at that time.

On the other hand, in Patent Document 2, when a worker perform a punching operation, he/she is captured and the image is stored by a face detection process if the face detection necessity information indicates it is required. In this case, if the illegal impersonation performs a punching operation, the image of the different person punching is stored, However, since no face authentication is performed at the time of punching of the worker, the administrator of the attendance management device must check the recorded punching image to find the illegal stamp (Paragraph 0014).

In view of the above, the first object of the present invention is to enable a face authentication of the users using an ID card for user identification and to provide an ID card capable of suppressing an increase of time required for the face authentication of each user even if a registered user is large, without using a server to store the data for an authentication of all users in advance.

Further, the 2nd object of the present invention is to prevent a confusion of the correspondence between face image information and identification information when storing face image information and identification information of a plurality of users to be registered. Further, the 3rd object of the present invention is to provide a method of manufacturing such an ID card, an ID card issuing device and a system used for issuing an ID card, and a face authentication device and a system used for performing a face authentication of a user using an ID card.

### Means for Solving the Problem

In order to solve at least one of the above problems, an ID card, according to the 1st aspect of the present invention, is an ID card for identifying a user including an IC chip, and includes: (a) the memory to store the feature data representing information about a plurality of feature points extracted from an image including a face of a user, which is encrypted using the unique ID code given to the IC chip as an encryption key and (b) a communication unit for transmitting the identification data file to the outside by communicating with the outside by a contact method or a non-contact method. A card image including an image of a user's face or identification information may be printed on the surface of the ID card.

The method of manufacturing an ID card, according to the 2 aspect of the present invention is a method of manufacturing an ID card for a user identification by performing processing on an IC card including an IC chip and having a communication function with an external device and a memory. It includes a step (a) to generate the feature date representing the information related to a plurality of feature extracted from the image including a face of a user based on the image data representing the image including a face of a user and a generate identification data file including the encrypted data which is encrypted using the unique ID code given to the IC chip as an encryption key and a step (b) of storing the identification data file in a memory of an IC card.

An ID card issuing device, according to the 3rd aspect of the present invention, is an ID card issuing device to issue ID card for a user identification by processing on an IC card with IC chip having a function of communicating with an external device and a memory. It includes a data processing unit to generate the feature date representing the information related to a plurality of a feature extracted from the image including a face of a user based on the image data representing the image including a face of a user and the generate identification data file including the encrypted data which is encrypted using the unique ID code given to the IC chip as an encryption key and a write control unit to generate write command to store the identification data file into a memory of an IC card.

A face authentication device, according to the 4th aspect of the present invention, is a face authentication device used for performing a face authentication of a user using an ID card. It includes a communication unit to communicate with the ID card being held by the user with a contact/non-contact method, the data reading unit to read from the ID card the identification data file including the feature data representing the information related to the multiple features extracted from the image including the stored user face and the stored user identification data and the unique ID code of the IC chip to decrypt the data including the feature data and the user identification data when detecting the ID card in accordance with the output signal from the communication unit, the image capture unit to input the image data representing the image including the user face captured when the user holds over the card once the card is detected by the data reading unit, the feature data generating unit to generate the feature data representing the information related to the multiple features extracted from the image including the user face captured in accordance with the image data inserted by the image capture unit, and the matching processing unit to judge if the captured user is same as the stored user by the score representing the degree of the matching by comparing the feature data generated by the feature data generating unit with the feature data of the unique data file.

The present invention can greatly reduce the amount of data and store the face image information in a memory of an ID card by using a feature data representing information regarding a plurality of feature points extracted from an image including a face of a user as the face image information. As a result, it is possible to perform the face authentication using an ID card for user identification, and to suppress an increase in time required for face authentication of each user even if a number of registered users are large without using a server for storing an authentication data for all users in advance.

Further, by storing the feature data and the identification information in the memory of the ID card in association with the feature data from the time at which the identification data file is created, it is possible to prevent confusion of the correspondence relationship between the face image information and the identification information when the face image information and the identification information of the plurality of users to be registered are stored. In addition, by encrypting the feature data and the user identification information of the user by using the unique ID code given to the IC chip as an encryption key, it is possible to prevent duplication of the ID card (illegal copy). Further, thanks to the present invention, it is possible to provide an ID card issuing system for issuing an ID card as described above, and a face authentication system for performing the face authentication of a user using an ID card as described above.

### BRIEF DESCRIPTION OF THE DRAWINGS

FIG. 1 is a block diagram showing a configuration example of an ID card issuing system according to an embodiment of the present invention;

FIG. 2 is a schematic diagram showing a configuration example of an ID card according to an embodiment of the present invention;

FIG. 3 is a block diagram showing the configuration example of the IC chip used for the ID card shown in FIG. 2.

FIG. 4 is a flowchart illustrating an ID card manufacturing method according to an embodiment of the present invention;

FIG. 5 is a block diagram illustrating a configuration example of a face authentication system according to an embodiment of the present invention;

### DESCRIPTION OF THE PREFERRED EMBODIMENTS

Hereinafter, embodiments of the present invention will be described in detail with reference to the accompanying drawings. The same components are denoted by the same reference numbers, and redundant descriptions thereof will be omitted.

### ID Card Issuing System

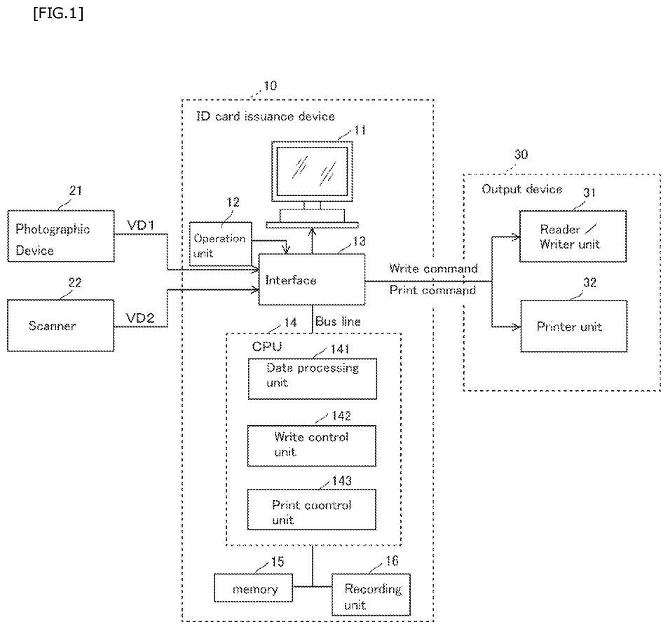

First, an ID card issuing system for issuing an ID card for a user identification will be described. FIG. 1 is a block diagram showing a configuration example of an ID card issuing system according to an embodiment of the present invention. As shown in FIG. 1, the ID card issuing system includes an ID card issuing device 10, an imaging device 21, a scanner 22, and an output device 30.

The ID card issuing device 10 includes, for example, a display 11, an operation unit 12, an interface 13, a CPU (central processing unit) 14, a memory 15, and a recording unit 16, and is used to perform processing on an IC card having a communication function with an external device and a memory, and to issue an ID card for a user identification. From the interface 13 to the recording unit 16 are connected to each other via a bus line.

The display 11 includes, for example, an LCD display, and displays an operation screen and an image of a user's face. The operation unit 12 includes, for example, a keyboard, a mouse, and the like, and is used to input various commands and data to the ID card issuing device 10. The interface 13 is connected to the display 11, the operation unit 12, the imaging device 21, the scanner 22, and the output device 30, and transmits various command and data between these devices and the CPU 14. Further, the interface 13 may be connected to a host system such as a Human resource system or a school system via a network such as the Internet.

The CPU 14 performs various calculations and the data processing according to software (including image processing software which generates a feature data based on an image data) recorded in the recording unit 16. The memory 15 includes, for example, a RAM (Random Access Memory) and temporarily stores various data supplied from the interface 13 and the data generated or processed by the CPU 14.

In addition to the above software, the recording unit 16 records various data used for an image processing. As a recording medium in the recording unit 16, a built-in hard disk, an external hard disk, a flexible disk, an MO, a MT, a ROM (read only memory), a CD-ROM, a DVD-ROM, or the like can be used. Here, the data processing unit 141, the write control unit 142, and the print control unit 143 are configured as functional blocks by the CPU 14 and the software recorded in the recording unit 16.

The image capturing device 21 includes, for example, a photographing box or a digital camera, and photographs a face of a user's face and generates an image data VD1 representing an image including a face of the user. In addition, the scanner 22 captures an image of a photographic sheet and generates an image data VD2 representing an image of the photographic sheet.

For example, a name of an organization to which a user belongs and a background pattern are printed on a photographic sheet. Alternatively, an image data VD2 prepared in advance by using software may be registered in the database in the recording unit 16 of the ID card issuing device 10. In this case, the scanner 22 can be omitted.

The output unit 30 includes, for example, a reader/writer unit 31 and a printer unit 32. The reader/writer unit 31 includes a communication circuit for communicating with an IC card according to a predetermined protocol. In accordance with a write command output from the ID card issuing device 10, the reader/writer 31 communicates with the IC card by a contact method or a non-contact method and store an identification data file including feature data representing a plurality of feature points extracted from an image including a face of a user and identification information of the user in a memory of an IC card.

The printer unit 32 prints a card image including an image of the user's face and/or identification information on the surface of the IC card in accordance with a print command output from the ID card issuing device 10. The reader/writer unit 31 and the printer unit 32 may be incorporated in one housing or may be incorporated in a separate housing.

### Operation of the ID Card Issuing System

Next, an operation example of the ID card issuing system shown in FIG. 1 will be described. An operator who is responsible for issuing an ID card operates an operation part 12 of an ID card issuing device 10 to input identification information of a user to an ID card issuing device 10. Alternatively, a file of identification information registered in advance in the database in the recording unit 16 may be read when designated by an operator. Alternatively, the identification information may be printed on a photographic sheet and captured by the scanner 22.

When an operator photographs a face of a user using an imaging device 21, an imaging device 21 generates an image data VD1 representing an image including a face of a user. In addition, when an operator captures the image of photographic sheet, the scanner 22 generates an image data VD2 representing the image of the photographic sheet. The image data VD1 and/or VD2 may be stored temporally in the memory of SD card or the like.

A data processing unit 141 of an ID card issuing device 10 reads an image data VD1 and VD2 from such an imaging device 21 and a scanner 22 or a memory of an SD card or the like via an interface 13 and stores the image data VD1 and VD2 in a memory 15. The data processing unit 141 may assign a file name including the identification information of the user to an image data file storing the image data VD1 or VD2.

Thereafter, based on the image data VD1 representing an image including the face of the user, the data processing unit 141 generates a feature data representing information relating to a plurality of feature points extracted from an image including a face of the user, and creates an identification data file including the feature data and the identification information of the user. As the identification information (identification code) of the user includes, for example, an ID code of the user, an employee number, a member number, a name, and/or a department to which the user belongs and the like.

Although the data processing unit 141 may generate an unique data by combining the feature data and the identification information of the user and create an identification data file storing the unique data, it is desirable to store the feature data and create an identification data file having a file name including the identification information of the user. In this case, it is possible to obtain the identification information of the user simply by referring to the file name. Further, it is desirable for the data processing unit 141 to assign a new extension (e.g., “blk”) different from the extension of the image data file (e.g., “jpg” or “gif”) to the identification data file. In this case, since the file name of the identification data file includes an extension different from the extension of the image data file in addition to the identification information of the user, it is easy to distinguish the file from the image data file.

Next, an example of the image processing for a generating feature data based on image data VD1 representing an image including a face of a user will be described. First, the data processing unit 141 roughly detects a position or a region of a human face in an image represented by the image data VD1 (hereinafter, also referred to as an “input image”).

Next, the data processing unit 141 performs a face recognition process on the image data VD1 based on the learning data recorded in advance in the recording unit 16, thereby extracting a plurality of feature points that specify the positions of a plurality of parts (e.g., the contour of the face, the eyes, the cheeks, and the lips) of the human face in the input image, and obtains the coordinates of those feature points.

For this face recognition processing, the recording unit 16 includes, for example, an image data representing an image obtained by photographing an object located at a standard distance along a predetermined optical axis from the imaging device 21 using a subject such as a standard human face or a model thereof, the coordinates of a plurality of feature points set in the image and a code specifying a part where the feature points are located are recorded in advance as a learning data.

Thanks to this face recognition process, it is possible to express a change in the shape of an object and a change in texture with a small number of parameters by dividing an image of a target face into a shape and a texture and performing dimensional compression on the basis of a principal component analysis. Thus, the shape and texture information can be represented with low dimensional parameters. Furthermore, a parameter is used which relates to an extensive change in the size of the object in which it is present in what size and in what orientation.

For example, the data processing unit 141 locally and extensively changes a model of a face in learning data according to these parameters to generate an image to be compared, and compares the generated image with an input image to obtain a parameter that minimizes an error. The determined parameter is used as feature data representing information related to a plurality of feature points extracted from an image including a face of a user. Thus, it is possible to reduce the data amount of the feature data (binary data) to 240 bytes or less (preferably, 120 bytes to 240 bytes).

As described above, the feature data used in the present embodiment does not represent the image itself, but information such as the shape and texture of a plurality of feature points extracted from an image based on the learning data, so that the original image cannot be reproduced based on the feature data. Also, the feature data has a sufficient amount of information to determine whether or not the captured user matches the registered user identified by the ID card, even if it is insufficient to locate a particular user from among the registered large number of users.

Further, the data processing unit 141 may scramble the data of the created identification data file using a dedicated tool. In the present application, a scrambling process is a process in which a data is converted or calculated in a predetermined procedure with respect to a data, or a sequence in which the data is rearranged, so that the data is changed into a random state different from the original state without impairing the contents of the data. For example, rather than sequentially storing the data of an identification data file in a memory of an IC card, it may be divided into a plurality of small chunks (chunks of data) and stored in a memory of an IC card in a predetermined order of random appearance. A face authentication system or the like for reading data which has been scrambled needs to perform a conversion process opposite to the scrambling process on the read data and decode the data. Thus, if the data of the identification data file is scrambled, it is possible to protect the contents of the data even if the identification data file flows out to the outside by hacking against an ID card issuing system or an issued ID card or by eavesdropping from a signal transmission path such as a network.

As a preferable example of the scrambling process, it is desirable that the data processing unit 141 encrypts the data of the identification data file using a secret encryption key. A face authentication system or the like for reading encrypted data needs to decrypt data using the same encryption key used for encryption. For example, in order to prevent a duplication (illegal copy) of an ID card, a unique ID code given to an IC chip used to manufacture an ID card may be used as an encryption key. In this case, the unique ID code given to the IC chip is stored in a storage area such as a memory which is separated from the memory in which the identification data file is stored.

When reading encrypted data from an IC chip, a face authentication system or the like reads a unique ID code given to an IC chip and decrypts the data using the ID code as an encryption key. On the other hand, when an identification data file stored in a memory of an IC chip is illegally copied into a memory of another IC chip, since an ID code read from another IC chip is not a correct encryption key, the encrypted data cannot be decrypted.

Further, the data processing unit 141 may generate a card image data representing a card image including an image of the face and/or the identification information of the user based on the image data VD1 representing an image including a face of a user, the image data VD2 representing an image of a photographic sheet, and/or identification information of a user. For example, the data processing unit 141 generates the card image data representing the card image including the face of the user and the identification data of the user by synthesizing an image of photographic sheet represented by the image data VD2 with enlarging a part of an image represented by the image data VD1 and an image of identification information.

The write control unit 142 generates a write command for storing the identification data file created by the data processing unit 141 in the memory of the IC card. Further, the print control unit 143 generates a print command for printing a card image on the surface of the IC card based on the card image data generated by the data processing unit 141.

In an output machine 30, a reader/writer unit 31 stores an identification data file in a memory (nonvolatile memory) of an IC card in accordance with a write command outputted from a write control unit 142 via an interface 13. Further, the reader/writer unit 31 may read and verify an identification data file from the nonvolatile memory of the IC card.

For example, when the capacity of a nonvolatile memory of an IC card is 1 Kbytes, the amount of data of a feature data in an identification data file is set to about 240 bytes, and the file name of an identification data file is set to 10 bytes or less to make a capacity of a user area in a nonvolatile memory of an IC card to be about 750 bytes.

As the non-contact type IC card according to the short distance wireless communication standard, Type A (Mifare), TypeB, FeliCa (Registered Trademark) or the like is applicable. Thus, it is desirable for the non-contact reader/writer unit 31 to correspond to 2 or more of them. When experimented using Mifare card which has 1 Kbyte capacity of the nonvolatile memory, it took 362 milliseconds to write 240 bytes (corresponding to 5 sectors) of a feature data, and it took 357 milliseconds to read the feature data.

The printer unit 32 has, for example, a color printing function, and prints a card image on the surface of the IC card in accordance with a print command outputted from the print control unit 143 via the interface 13. Thus, a card image including an image of the face and identification information of the user is printed on the surface of the IC card. Further, the output device 30 may be configured to press the IC card to provide unevenness.

### ID Card

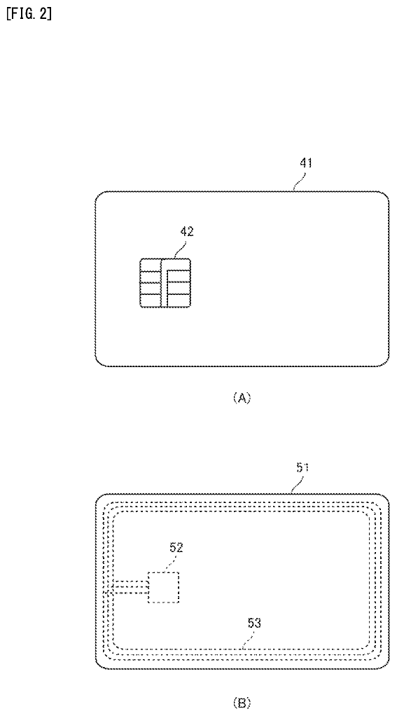

Next, an ID card issued by the ID card issuing system shown in FIG. 1 will be described. FIG. 2 is a schematic diagram showing a configuration example of an ID card according to an embodiment of the present invention. FIG. 2 (A) shows a contact ID card, and FIG. 2 (B) shows a non-contact ID card. Although not shown in FIG. 2, a card image including an image of the face and/or identification information of the user is printed on the surface (front surface) of the ID card.

As shown in FIG. 2 (A), an IC module 42 including an IC chip (semiconductor integrated circuit device) is mounted on a substrate 41 containing an insulating material such as PVC (polyvinyl chloride), ABS (Acrylonitrile Butadiene Styrene Resin), PET (Polyethylene Terephthalate), or the like.

The IC module 42 has a plurality of module terminals that contact a plurality of reader/writer terminals of the output device 30 (FIG. 1) and directly contact with the reader/writer terminals of the output device 30. Since such a contact ID card can be reliably communicated, it is desirable to use such an ID card in the field of a payment, an authentication, or the like, which requires a strong security, such as a credit card or a cash card.

As shown in FIG. 2 (B), a non-contact ID card includes an IC chip 52 and a coil 53 serving as an antenna in a base material 51 including an insulating material such as PVC, ABS, or PET. When an ID card is placed over a magnetic field generated by the reader/writer unit 31 (FIG. 1) of the output unit 30, a power supply voltage is supplied to the IC chip 52 by the coil 53, and the IC chip 52 and the reader/writer unit 31 exchange data by wireless communication. Such a non-contact ID card is preferably used in an area requiring more convenience, such as an entry/exit management and a railroad examination.

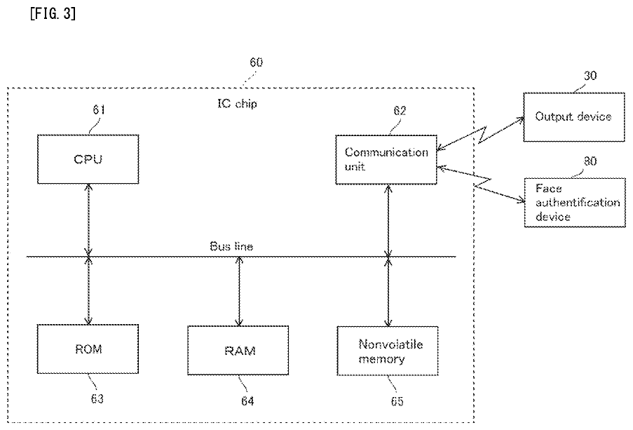

FIG. 3 is a block diagram showing a configuration example of an IC chip used in the ID card shown in FIG. 2. As shown in FIG. 3, the IC chip 60 includes, for example, a CPU 61, a communication unit 62, a ROM 63, a RAM 64, and a nonvolatile memory 65. The CPU 61 to the nonvolatile memory 65 are connected to each other via a bus line.

The CPU 61 performs various operations and data processing in accordance with software (OS and application software) stored in the ROM 63. The communication unit 62 includes a communication circuit which communicates with the external output device 30 and the face authentication device 80 according to a predetermined protocol, and communicates with the external device by a contact method or a non-contact method. The RAM 64 temporarily stores various data supplied from the outside, data generated or processed by the CPU 61, and the like.

The nonvolatile memory 65 is constituted by, for example, a flash memory or the like and stores an identification data file supplied from the output device 30 to the IC chip 60. The identification data file includes a feature data representing information relating to a plurality of feature points extracted from an image including a face of a user, and an identification information of the user. For example, the identification data file stores feature data and has a file name including user identification information. Further, the data of the identification data file may be scrambled.

Further, the nonvolatile memory 65 may store data (a program, an instance, and/or various kinds of information) relating to an application installed on an ID card. For example, an application for realizing a cash card function, a predetermined number of credit settlement applications, a setting application for changing a priority order between applications for a credit settlement application by the user, and a setting application for changing availability are installed in an ID card.

When the communication unit 62 receives a command for writing an identification data file from the output device 30 by performing communication with the output device 30 by a contact method or a non-contact method, it transfers the data file to the CPU 61. In accordance with the write command, the CPU 61 writes the identification data file supplied from the output device 30 via the communication unit 62 into the nonvolatile memory 65.

Further, when the communication unit 62 receives a command to read an identification data file from the face authentication device 80 which communicates with the unit 62 by a contact method or a non-contact method, it transfers the command to the CPU 61. In accordance with the read command, the CPU 61 reads the identification data file from the nonvolatile memory 65 and supplies it to the communication unit 62. The communication unit 62 transmits the identification data file to the face authentication device 80 by performing communication with the face authentication device 80 by a contact method or a non-contact method.

### ID Card Manufacturing Method

Next, a method of manufacturing an ID card for user identification by performing a processing on an IC card having an external communication function and a memory using the ID card issuing system shown in FIG. 1 will be described.

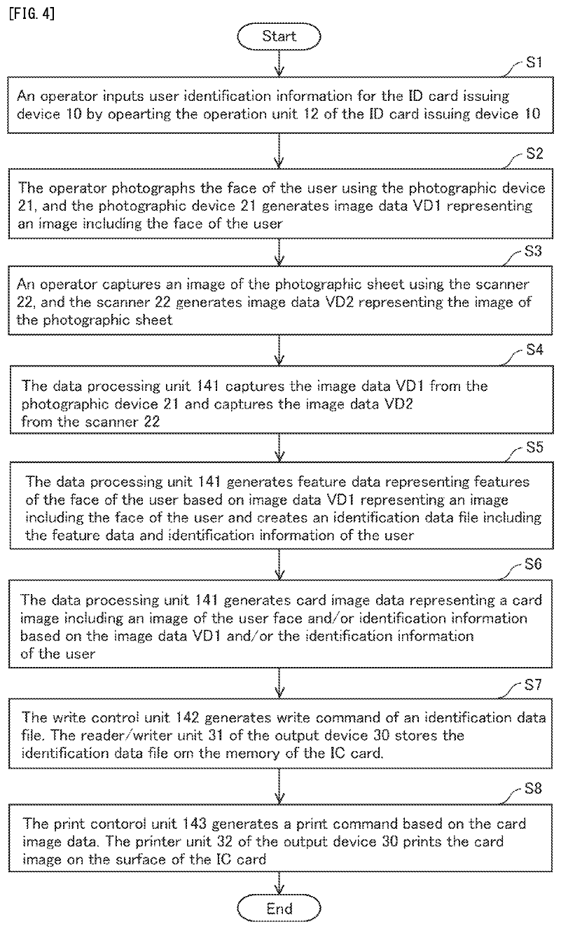

FIG. 4 is a flowchart illustrating an ID card manufacturing method according to an embodiment of the present invention. Note that the ID card manufacturing method according to the present invention does not need to be provided with all the steps described below, and a part thereof can be omitted.

In step S1 of FIG. 4, an operator who is responsible for issuing an ID card operates the operation unit 12 of the ID card issuing device 10 shown in FIG. 1 to input the identification information of the user into the ID card issuing device 10. Alternatively, a file of identification information registered in advance in the database of the recording unit 16 or the like may be read when designated by an operator.

In step S2, by an operator taking an image of a user's face using the image capturing apparatus 21, the image capturing apparatus 21 generates image data VD1 representing an image including the user's face. The processing in steps Si and S2 may be performed sequentially for a plurality of users.

In step S3, by the operator capturing an image of the photographic sheet using the scanner 22, the scanner 22 generates an image data VD2 representing an image of the photographic sheet. For example, a name and a background pattern of an organization to which a user belongs are printed on a photographic board. Thereafter, in step S4, the operator operates the operation unit 12 while looking at the display 11, whereby the data processing unit 141 takes in the image data VD1 from the image capturing apparatus 21, captures the image data VD2 from the scanner 22, and stores the image data VD1 and VD2 in the memory 15. In step S5, the data processing unit 141 generates a feature data representing information regarding a plurality of feature points extracted from an image including a face of a user based on the image data VD1 representing an image including a face of the user, and creates an identification data file including the feature data and the identification information of the user. For example, the identification data file stores feature data and has a file name including user identification information.

Further, the data processing unit 141 may scramble the data of the created identification data file. As a preferable example of the scrambling process, it is desirable that the data processing unit 141 encrypts the data of the identification data file using a secret encryption key. For example, in order to prevent illegal copying of an ID card, an ID code unique to an IC chip used for manufacturing an ID card may be used as an encryption key.

In step S6, the data processing unit 141 generates a card image data representing a card image including an image of the face and/or identification information of the user based on the image data VD1 representing an image including the user's face and/or the identification information of the user. In step S7, the write control unit 142 generates a write command for storing the identification data file created by the data processing unit 141 in the memory of the IC card, and the interface 13 outputs a write command to the output unit 30.

The reader/writer unit 31 of the output device 30 performs communication with the IC card by a contact method or a non-contact method according to the write command, thereby storing the identification data file in the memory of the IC card.

In step S8, the print control unit 143 generates a print command for printing a card image on the surface of the IC card based on the card image data generated by the data processing unit 141, and the interface 13 outputs a print command to the output device 30. A printer unit 32 of the output device 30 prints a card image on the surface of an IC card according to a print command. A card image including an image of the face and/or identification information of the user is thereby applied to the surface of the IC card.

Then, the ID card is completed.

### Face Authentication System

Next, a face authentication system used for an entry/exit management in a facility such as a company will be described as an example of a face authentication system which performs a face authentication of a user using an ID card as described above. In this face authentication system, a pre-registered user possesses a dedicated ID card according to the present embodiment, and the face authentication is performed for a personal confirmation at the entrance/exit of the facility.

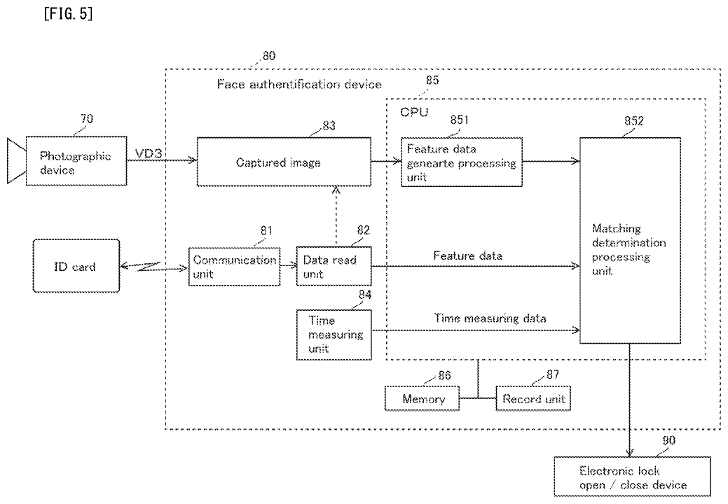

FIG. 5 is a block diagram showing a configuration example of a face authentication system according to an embodiment of the present invention. As shown in FIG. 5, the face authentication system includes an imaging device 70 and a face authentication device 80, and may further include an electronic lock opening/closing device 90 and the like.

For example, the image capturing device 70 includes a live camera such as a web camera, and photographs a face of a user who presents an ID card and generates an image data VD 3 representing an image including a face of the user. In addition, the image capturing device 70 has an interface such as a USB or the like capable of real-time image transfer, and the image data VD3 obtained by photographing the user's face is supplied to the face authentication device 80 via the interface.

The face authentication device 80 includes, for example, a communication unit 81, a data reading unit 82, an image capturing (image data capturing unit) 83, a time measuring unit 84, a CPU 85, a memory 86, and a recording unit 87, and is used for performing a face authentication of a user using an ID card having a communication function with an external device and a memory. The CPU 85 to the recording unit 87 are connected to each other via a bus line.

The communication unit 81 includes a communication circuit for communicating with an ID card according to a predetermined protocol, and communicates with an ID card presented by a user in a contact or non-contact manner. For example, the communication unit 81 corresponding to the contact type ID card has a plurality of reader/writer terminals in contact with a plurality of module terminals of the ID card, and performs communication in direct contact with the module terminal of the ID card. Further, the communication unit 81 corresponding to the ID card of the non-contact type generates a magnetic field for supplying a power supply voltage to the ID card, and exchanges data with the ID card by a wireless communication.

The data reading unit 82 detects an ID card based on an output signal of the communication unit 81, and reads the identification data file from the ID card. The identification data file includes an feature data representing information relating to a plurality of feature points extracted from an image including the face of the registered user, and identification information of the registered user. For example, the identification data file stores the feature data and has a file name including identification information of the registered user.

In this case, when the data of the identification data file is scrambled, the data reading unit 82 performs a conversion process opposite to the scrambling process on the read data and decodes the data of the identification data file. For example, if the data of the identification data file is encrypted, the data reading unit 82 decrypts the data of the identification data file using the same encryption key used for the encryption.

When an ID card is detected by a data reading part 82, an image capture 83 fetches an image data VD3 representing an image including a face of a user photographed when an ID card is presented from an imaging device 70. Thus, it is possible to acquire an image data representing an image when the user's face approaches the imaging device 70.

For example, when the image capture 83 detects an ID card by the data reading unit 82, it starts to fetch the image data of a plurality of frames, and the image data of the frame suitable for generating the feature data may be selected from those frames.

The clock unit 84 includes, for example, an oscillator and a counter, and generates a timing data indicating a measurement time by incrementing a count value of the counter in synchronization with a clock signal generated by the oscillator, and supplies the count data to the CPU 85.

The CPU 85 performs various calculations and a data processing according to software (including image processing software which generates a feature data based on an image data) recorded in the recording unit 87. The memory 86 includes, for example, a RAM (Random Access Memory), and temporarily stores an identification data file supplied from the data reading unit 82, image data supplied from the image capture 83, and feature data generated or processed by the CPU 85.

In addition to the above software, the recording unit 87 records various data used for an image processing. As a recording medium in the recording unit 87, a built-in hard disk, an external hard disk, a flexible disk, a MO, MT, ROM, CD ROM, a DVD-ROM, or the like can be used. The feature data generation processing unit 851 and the matching determination processing unit 852 are configured as functional blocks by the CPU 85 and the software recorded in the recording unit 87.

Further, identification information of all registered users may be recorded in advance in the recording unit 87. In this case, only when the identification information of the identification data file read by the data reading unit 82 matches the identification information recorded in the recording unit 87, the CPU 85 may start the following processing.

The feature data generation processing unit 851 generates feature data representing information on a plurality of feature points extracted from an image including a face of a user photographed by the image capturing device 70, by performing image processing based on image data captured by the image capturing unit 83. This image processing may be the same as that performed by the data processing unit 141 of the ID card issuing device 10 shown in FIG. 1. The matching determination processing unit 852 compares the feature data generated by the feature data generation processing unit 851 with the feature data of the identification data file. A score indicating the matching degree of both is generated, and based on the generated score, whether the user photographed by the imaging device 70 matches the registered user specified by the ID card or not.

For example, the matching determination processing unit 852 compares the generated score with a threshold value or more. Alternatively, if the score is larger than the threshold, it is determined that the user captured by the imaging device 70 matches the registered user, and otherwise, it is determined that the user captured by the imaging device 70 does not match the registered user. In this case, when the matching determination processing unit 852 determines that the 1 user do not match, the matching determination processing unit 852 may repeat the determination a predetermined number of times while lowering the threshold value for the same user.

For example, in the case where the score when comparing the same characteristic data is set to 100%, the matching determination processing unit 852 sets a threshold value to 90% and determines. In the case where e matching determination processing unit determines that the user do not match in the first judgment, the matching determination processing unit 852 decrease a threshold value to 80% and determines again. Further, in the case where the second judgment also do not match, a threshold value is lowered to 70% in the final determination. when the user finally determined to be inconsistent, the user can import the image data VD3 of the capturing unit 83 by presenting the ID card to the removing unit 82 again.

Further, when the matching determination processing unit 852 determines that the user captured by the imaging device 70 matches the registered user identified by the ID card, the matching determination processing unit 852 may record time data indicating a time at which the ID card is detected in the recording unit 87 in association with the user identification information. Thus, it is possible to use the time measurement data for the attendance management.

In addition, when the matching determination processing unit 852 determines that the user captured by the imaging device 70 matches the registered user specified by the ID card, the matching determination processing unit 852 may control the electronic lock opening/closing device 90 to open an electronic lock provided at an entrance/exit gate or a door of the facility. After the user has passed through the entrance/exit gate or the door, the matching determination processing unit 852 controls the electronic lock opening/closing device 90 to close the electronic lock again.

According to this embodiment, by using the feature data representing the information on the plurality of feature points extracted from the image including the face of the user as the face image information, it is possible to greatly reduce the amount of data and store the face image information in the memory of the ID card. As a result, it is possible to perform an face authentication using an ID card for user identification, and to suppress an increase in time required for the face authentication of each user even if a number of registered users are large without using a server for storing an authentication data for all users in advance. Further, by storing the feature data and the identification information in the memory of the ID card in association with the feature data from the moment the identification data file is created, it is possible to prevent a confusion of the correspondence relationship between the face image information and the identification information when the face image information and the identification information of the plurality of users to be registered are stored.

In the above embodiment, a case has been described in which the face authentication system is used for an entry/exit management and an attendance management in a facility; however, the present invention is not limited to this embodiment. It may be used, for example, a settlement in a financial institution, a security management of a terminal such as a computer or a copying machine, a management of attendance such as a conference, a management of purchase of a meal ticket at a restaurant, an issuance management of a student certificate, an official certificate, a certificate for purchasing a commuter ticket, a management of various kinds of information, or the like. Thus, many variations within the spirit of the present invention are possible by one of ordinary skill in the art.

### INDUSTRIAL APPLICABILITY

The present invention is applicable to an ID card used for identifying a user in an entry/exit management or a settlement in a financial institution, a method of manufacturing of an ID card, an ID card issuing device and system, and a face authentication device and a system.

1-11. (canceled)

12. An identification (ID) card issuing device configured to issue ID cards for user identification by processing an integrated circuit (IC) card, the IC card including an IC chip, an external communication unit, and a memory, the ID card issuing device comprising:
a data processing unit; and
a write control unit,
wherein the data processing unit is configured to:
extract feature data from an image file representing an image that includes a face of the user; and
generate identification data including encrypted data, the encrypted data including the feature data and user identification data, an encryption key for the encrypted data being a unique ID code of the IC chip,
wherein the write control unit is configured to generate a write command to encode the identification data as an identification data file in the memory of the IC card.

13. The ID card issuing device according to claim 12, wherein the data processing unit is configured to scramble data including the feature data and the user identification information by the encryption.

14. The ID card issuing device according to claim 12, further comprising a print control unit configured to generate a print command for printing a card image on a surface of the IC card based on card image data representing the face and the unique data of the user, generated by the data processing unit based on the image data including the face of the user and identification information of the user.

15. An ID card issuing system, comprising:
the ID card issuing device according to claim 14;
an imaging device configured to photograph the face of the user to generate the image data; and
the print control unit,
wherein the print control unit is configured to:
print the card image on the surface of the IC card in accordance with the print command; and
store the identification data into the memory of the IC card by communication between the IC card and the print control unit in accordance with the write command.

16. An identification (ID) card with an integrated circuit (IC) chip suitable for user identification, the ID card comprising:
a memory in which an identification data file is stored; and
a communication unit configured to transmit the identification data file to an external device by communication between the external device and the communication unit,
wherein the identification data file includes:
feature data representing features extracted from an image of a face of the user;
user identification data; and
encrypted data whose encryption key is a unique ID code of the IC chip.

17. The ID card of claim 16, wherein the identification data file includes the feature data, and wherein the identification data file has a file name including the user identification data.

18. A method of manufacturing an identification (ID) card suitable for user identification based on an integrated circuit (IC) card that includes an IC chip having an external communication component and a memory, the method comprising:
generating the feature data representing the multiple feature data extracted from the image with the user face according to the image data representing the image including the user face and generating the identification data file including the feature data and the identification data of the user encrypted with the unique ID code of the IC chip; and
storing the identification data file into the memory of the IC card.

19. The method for manufacturing the ID card of claim 18, further comprising:
Generating the card image data representing the card image including the user face and the unique data image based on image data representing the image including the user face and the user unique data; and
printing the card image based on the card image data on the surface of the IC card.

20. A face authentication device configured to perform face authentication of a user with an identification (ID) card with an integrated circuit (IC) chip, the face authentication device comprising:
a communication unit configured to communicate with the ID card of the user;
a data reading unit configured to read from the ID card an identification data file including feature data representing information related to multiple features extracted from an image including the face of the user, stored user identification data, and the unique ID code of the IC chip to decrypt the data including the feature data and the user identification data when detecting the ID card in accordance with an output signal from the communication unit;
an image capture unit configured to input the image data representing the image including the user face captured when the user holds over the card once the card is detected by the data reading unit;
a feature data generating unit configured to generate the feature data representing the information related to the multiple features extracted from the image including the user face captured in accordance with the image data input by the image capture unit; and
a matching processing unit to determine whether the captured user is the same as the stored user based on a score representing a degree of the matching by comparing the feature data generated by the feature data generating unit with the feature data of the unique data file.

21. The face authentication device of claim 20, further configured to store clocking data of the time when the ID card is detected with the user unique data into the recording unit under a condition that the matching processing unit determines that the captured user is the stored user.

22. A face authentication system comprising the face authentication device of the claim 20 and an imaging device configured to capture the user face holding the ID card and generate the image data.

23. The ID card issuing device according to claim 13, further comprising a print control unit configured to generate a print command for printing a card image on a surface of the IC card based on card image data representing the face and the unique data of the user, generated by the data processing unit based on the image data including the face of the user and identification information of the user.

24. An ID card issuing system, comprising:
the ID card issuing device according to claim 23;
an imaging device configured to photograph the face of the user to generate the image data; and
the print control unit,
wherein the print control unit is configured to:
print the card image on the surface of the IC card in accordance with the print command; and
store the identification data into the memory of the IC card by communication between the IC card and the print control unit in accordance with the write command.

25. A face authentication system comprising the face authentication device of the claim 21 and an imaging device configured to capture the user face holding the ID card and generate the image data.
